(19) United States
(12) Patent Application Publication
(10) Pub. No.: US 2025/0141873 A1
(43) Pub. Date: May 1, 2025

(54) QUORUM-BASED AUTHORIZATION TECHNIQUES

(71) Applicant: Rubrik, Inc., Palo Alto, CA (US)

(72) Inventors: Xiaoqing Tao, San Jose, CA (US); Wesley Pang, San Francisco, CA (US); Michelle Nguyen, Campbelle, CA (US); Nathan Narasimhan, San Francisco, CA (US); Hao Wu, Mountain View, CA (US); Shrihari Kalkar, Santa Clara, CA (US); Michael Wronski, Johns Creek, GA (US); Haijin He, South Setauket, NY (US); Barsa Tandukar, San Jose, CA (US); Seungyeop Han, San Jose, CA (US); Alex Medovar, San Francisco, CA (US); Raghuram Janakiraman, Woodinville, WA (US)

(21) Appl. No.: 18/385,275

(22) Filed: Oct. 30, 2023

(51) Int. Cl. H04L 9/40

(52) U.S. Cl. CPC H04L 63/102; H04L 63/101; H04L 63/20

(57) ABSTRACT

A data management system (DMS) may receive an indication of a configuration for a quorum-based authorization (QAuth) policy that controls interactions between two or more users and a security cloud service of the DMS. The configuration may include a policy scope for the QAuth policy, protected actions that trigger the QAuth policy, and compute objects to which the QAuth policy is assigned. The DMS may receive an instruction to assign a set of role-based access control (RBAC) permissions associated with the QAuth policy to a first user. The DMS may receive a request to perform a protected action on at least one compute object to which the QAuth policy is assigned. In response to the request, the DMS may trigger a two-person rule (TPR) enforcement mechanism of the QAuth policy by requesting approval from the first user with the set of RBAC permissions.

### FIELD OF TECHNOLOGY

The present disclosure relates generally to data management, including techniques for quorum-based authorization (QAuth) techniques.

### BACKGROUND

A data management system (DMS) may be employed to manage data associated with one or more computing systems. The data may be generated, stored, or otherwise used by the one or more computing systems, examples of which may include servers, databases, virtual machines (VMs), cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIGS. 1 and 2 illustrate examples of computing environments that support quorum-based authorization (QAuth) techniques in accordance with aspects of the present disclosure.

FIGS. 3 through 7 show examples of user interfaces that support QAuth techniques in accordance with aspects of the present disclosure.

FIG. 8 shows an example of a QAuth request that supports QAuth techniques in accordance with aspects of the present disclosure.

FIG. 9 shows an example of a process flow that supports QAuth techniques in accordance with aspects of the present disclosure.

FIG. 10 shows a block diagram of an apparatus that supports QAuth techniques in accordance with aspects of the present disclosure.

FIG. 11 shows a block diagram of an authorization manager that supports QAuth techniques in accordance with aspects of the present disclosure.

FIG. 12 shows a block diagram of a system that supports QAuth techniques in accordance with aspects of the present disclosure.

FIG. 13 shows a flowchart illustrating a method that supports QAuth techniques in accordance with aspects of the present disclosure.

### DETAILED DESCRIPTION

Some backup and recovery systems may use access control schemes to ensure that only authorized users can perform sensitive actions like changing encryption settings or deleting files from a database. In some cases, a user may have a set of permissions that define actions the user can perform and resources on which the user can perform the actions. For example, a first user may have permission to update service level agreement (SLA) settings of a cluster, while a second user may have permission to enable/disable protection for specific objects (e.g., virtual machines (VMs) or nodes) within the cluster. In some cases, these permissions may be assigned, removed, or modified by a system administrator. Access control schemes may reduce the likelihood of users accidentally (or maliciously) making changes to a backup and recovery system.

In some cases, however, an unauthorized user (also referred to as a malicious actor or an attacker) may bypass security measures by creating a new user account using a compromised user account with administrative privileges. For example, an attacker (or an external user impersonating a system administrator) may create a fraudulent user account and use the fraudulent user account to delete data or tamper with the system. Likewise, the attacker could reset the password and multi factor authentication (MFA) settings of another user account to gain access to the user account. Thus, some access control schemes may leave systems vulnerable to data breaches, unauthorized data exposure, cyberattacks, etc.

In accordance with the techniques described herein, a data management system (DMS) may use a quorum-based authorization (QAuth) policy to prevent attackers and other users from taking unauthorized actions within the DMS. To configure the QAuth policy, an administrative user may interact with a security cloud service of the DMS (for example, via one or more user interfaces). The security cloud service may enable the administrative user to select one or more of: a policy scope (e.g., objects, clusters, or SLA domains) for the QAuth policy; a set of actions that require two-person rule (TPR) enforcement; a set of resources (e.g., VMs, nodes, objects, clusters) to which the QAuth policy is assigned; and other relevant parameters.

As described herein, policy scope generally refers to the category of selectable resources presented to the user. These resources may include (but are not limited to) VMs, hosts, databases, clusters, SLA domains, and the like. To create a policy, users can select an action category, such as system configuration policy or a data management policy. If the data management policy option is chosen, users can then select the resource category/policy scope, such as objects, clusters, or SLA domains. Based on the resource category selected, the user can then add relevant inventory objects, clusters, or SLA domains to the policy. Thus, a policy may comprise a set of actions and a corresponding set of resources.

Once the QAuth policy is created, the administrative user can add the policy to a role-based access control (RBAC) role and assign the role to one or more users (or groups of users). Users assigned to this RBAC role can approve specific actions within the scope of the QAuth policy. In some implementations, changes to the QAuth policy (e.g., reducing the object scope of the QAuth policy, adding an exempt service account to the QAuth policy) may require approval from another user with approval privileges/permissions. Unlike other TPR schemes, however, the approver can have additional RBAC roles/privileges (aside from creating/managing user access permissions), thereby supporting greater operational flexibility and improved customization.

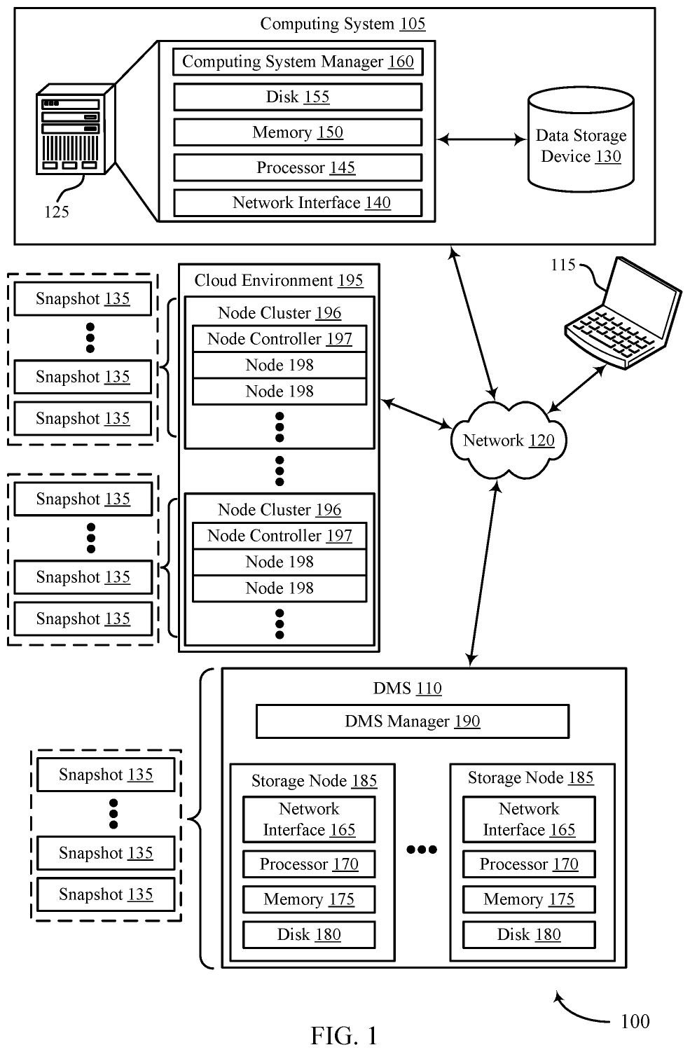

FIG. 1 illustrates an example of a computing environment 100 that supports QAuth techniques in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device or a virtual machine (VM). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more VMs, the resources of which are made available to one or more client devices over a network (e.g., to one or more computing devices 115 over the network 120).

In some examples, the computing system 105 or aspects thereof may implement or be implemented by one or more VMs. The one or more VMs may run various applications, such as a database server, an application server, or a web server. For example, a server 125 may be used to host (e.g., create, manage) one or more VMs, and the computing system manager 160 may manage a virtualized infrastructure within the computing system 105 and perform management operations associated with the virtualized infrastructure. The computing system manager 160 may manage the provisioning of VMs running within the virtualized infrastructure and provide an interface to a computing device 115 interacting with the virtualized infrastructure. For example, the computing system manager 160) may be or include a hypervisor and may perform various VM-related tasks, such as cloning VMs, creating new VMs, monitoring the state of VMs, moving VMs between physical hosts for load balancing purposes, and facilitating backups of VMs. In some examples, the VMs, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a VM, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, VMs, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

In accordance with the QAuth techniques described herein, the DMS 110 may receive an indication of a configuration for a QAuth policy that controls interactions between two or more users and a security cloud service of the DMS 110. The configuration may include a policy scope for the QAuth policy, one or more protected actions that trigger the QAuth policy, and one or more compute objects to which the QAuth policy is assigned. The DMS 110 may receive an instruction to assign a set of role-based access control (RBAC) permissions associated with the QAuth policy to a first user of the two or more users. The DMS 110 may receive (e.g., from a second user) a request to perform a protected action on at least one compute object of the one or more compute objects to which the QAuth policy is assigned. In response to the request, the DMS 110 may trigger a two-person rule (TPR) enforcement mechanism by requesting approval from the first user with the set of RBAC permissions. Accordingly, the DMS 110 may execute the protected action on the at least one compute object after receiving the approval from the first user with the set of RBAC permissions.

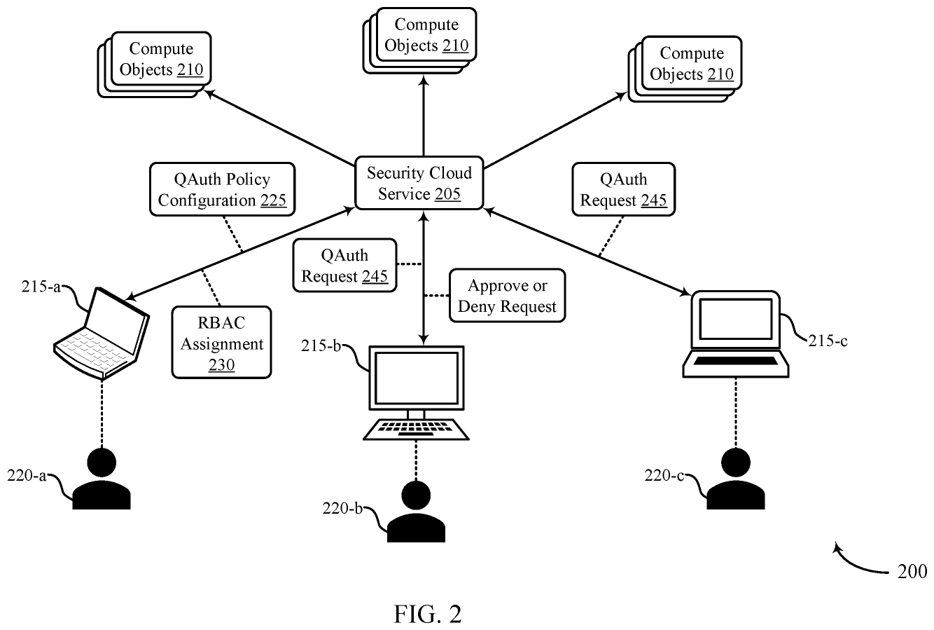

FIG. 2 shows an example of a computing environment 200 that supports QAuth techniques in accordance with aspects of the present disclosure. The computing environment 200 may implement one or more aspects of the computing environment 100. For example, the computing environment 200 includes a security cloud service 205, which may be implemented or otherwise supported by the DMS 110, as shown and described with reference to FIG. 1. The computing environment 200 also includes various computing devices 215, which may be examples of the computing devices 115 shown and described with reference to FIG. 1.

As described herein, the DMS 110 may use access control schemes to ensure that only authorized users 220 can perform sensitive actions like changing encryption settings or deleting files from a database. In some cases, a user 220 may have a set of permissions that define actions the user 220 can perform and resources on which the user 220 can perform the actions. For example, a user 220-c may have permission to update SLA settings of a cluster, while a user 220-b may have permission to enable/disable protection for specific compute objects 210 (e.g., VMs, databases, nodes, hosts, and the like). In some cases, these permissions may be assigned, removed, or modified by a system administrator (such as the user 220-a). Access control schemes may reduce the likelihood of users 220 accidentally (or maliciously) making changes to the DMS 110.

In some cases, however, an unauthorized user 220 (also referred to as a malicious actor or an attacker) may bypass security measures by using a compromised user account with administrative privileges to create a new user account or modify the privileges of an existing user account. For example, an attacker (or an external user impersonating a system administrator) may create a fraudulent user account and use the fraudulent user account to delete data or tamper with the DMS 110. Likewise, the attacker could reset the password and MFA settings of another user account to gain access to the user account. Thus, some access control schemes may leave the DMS 110 vulnerable to data breaches, unauthorized data exposure, cyberattacks, etc.

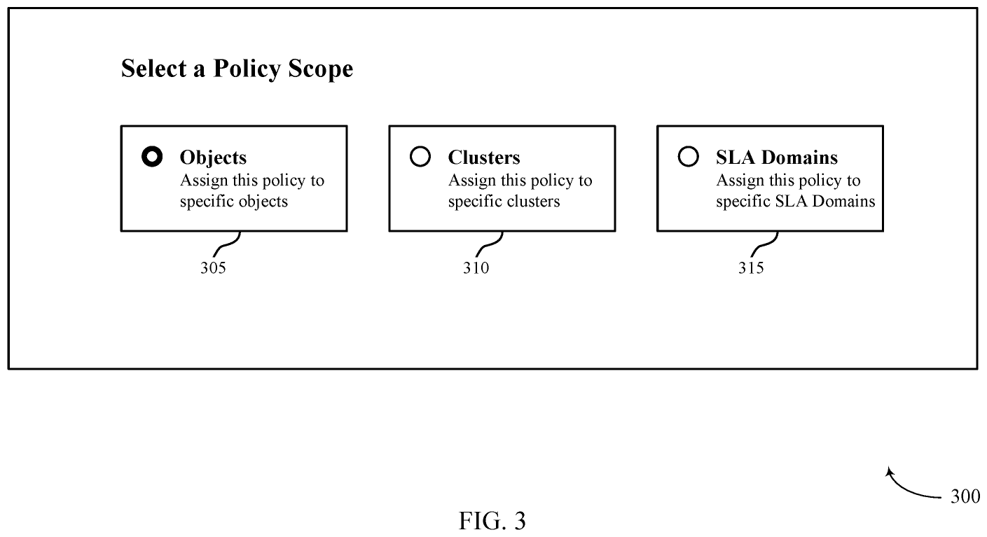

In accordance with the techniques described herein, the DMS 110 may use a QAuth approach to prevent attackers and other users from taking unauthorized actions within the DMS 110. To configure the QAuth policy, the user 220-a (e.g., an administrative user) may interact with the security cloud service 205 of the DMS 110 (for example, via one or more of the user interfaces shown and described with reference to FIGS. 3 through 7). The security cloud service 205 may enable the user 220-a to select a QAuth policy configuration 225, which may include a policy scope (e.g., objects, clusters, or SLA domains) for the QAuth policy, a set of protected actions that require TPR approval, a set of compute objects 210 (e.g., VMs, nodes, objects, clusters) to which the QAuth policy is assigned, and other relevant parameters.

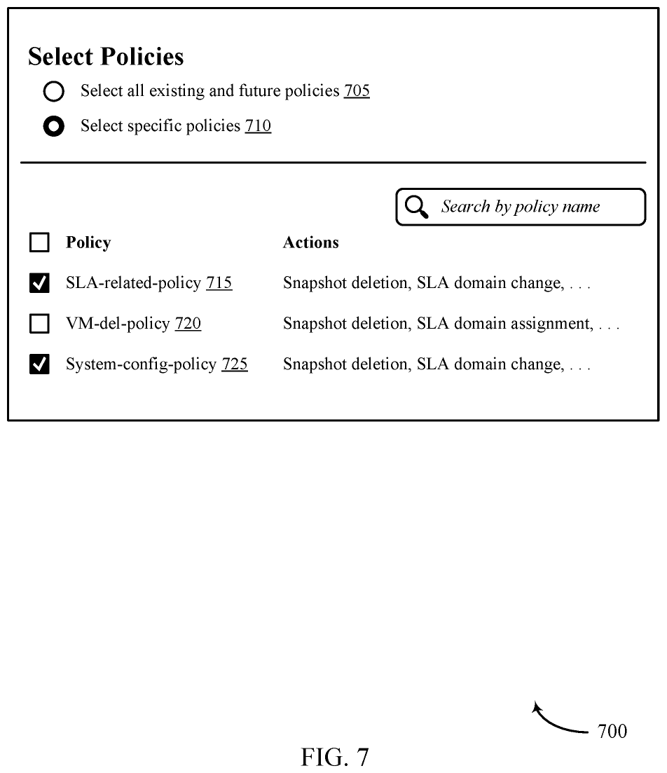

Once the QAuth policy is created, a QAuth administrator can add the policy to a RBAC role and assign the role to one or more users (for example, by interacting with the user interface 700, as shown and described with reference to FIG. 7). If, for example, the user 220-a is an administrative user or a user with manage user access permissions, the user 220-a may be unable to approve any requests. The RBAC assignment 230 provided by the user 220-a may enable the user 220-b (e.g., a QAuth approver) to approve specific actions within the scope of the QAuth policy. In some implementations, changes to the QAuth policy (e.g., reducing the object scope of the QAuth policy, adding an exempt service account to the QAuth policy) may require approval from another user 220 with approval privileges/permissions (such as a user 220 assigned to a QAuth admin role). Unlike other TPR schemes, however, the user 220-b can have additional RBAC roles/privileges (aside from creating/managing user access permissions), thereby supporting greater operational flexibility and improved customization.

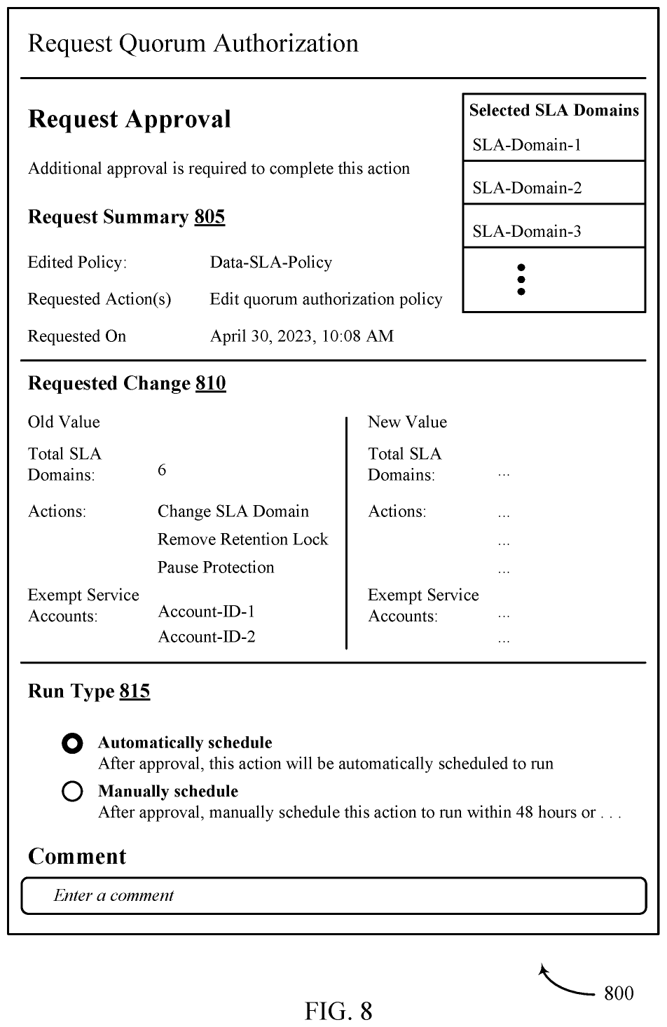

When another user (such as the user 220-c) attempts to perform a protected action on a given compute object 210, a QAuth request 245 may be sent to the user 220-b. As described with reference to FIG. 8, the QAuth request 245 may include various details, including (but not limited to) information associated with the user 220-c, an indication of the requested action(s) and corresponding compute object(s) 210, information associated with the QAuth policy triggered by the request, and so on. In some examples, the QAuth request 245 may enable the user 220-c to specify whether the requested action(s) should be automatically performed or manually triggered once the QAuth request 245 is approved.

FIG. 3 shows an example of a user interface 300 that supports QAuth techniques in accordance with aspects of the present disclosure. The user interface 300 may implement one or more aspects of the computing environment 100 and/or the computing environment 200. For example, the user interface 300 may be configured by or otherwise associated with the security cloud service 205, as shown and described with reference to FIG. 2. The user interface 300 may be rendered or otherwise displayed on the computing device 215-a associated with the user 220-a (e.g., a global administrator), as shown and described with reference to FIG. 2. The user interface 300 depicted in the example of FIG. 3 may enable the user 220-a to select or otherwise configure a policy scope for a QAuth policy.

As described herein, some organizations may prefer to maintain separation between data owners, security owners, and business owners. For example, some groups within the organization (such as the legal and/or security team) may want to ensure that data is not corrupted or changed, while other groups (such as the data owners) may want to ensure that data is not deleted. The QAuth techniques described herein ensure that one user cannot perform critical operations (e.g., actions that result in data destruction) on their own. Performing such operations may require approval from an identified secondary approver (such as the user 220-b). The assigned reviewer/approver has to review/agree on the changes before the operation is executed. Using the QAuth techniques described herein, a malicious user must compromise at least two accounts (one with requesting permissions and one with approval privileges) before they can make destructive changes to the system. The QAuth techniques described herein can help prevent malicious actors with stolen credentials from deleting or corrupting data protected by the DMS 110.

A QAuth policy may have an object-level policy per operation, and may provide greater flexibility to assign approvers to specific policies. The number of approvers required may be configurable (e.g., any number greater than 2). In some implementations, QAuth policies may be defined across multiple clusters, and QAuth approvers (such as the user 220-b) may also have non-approver permissions (except for updating/managing user access permissions). The QAuth techniques described herein may support two different execution schemes: automatic execution after approval; and manual execution after approval. The described techniques may also support multi-tenancy and policy bypass for specific service accounts.

Aspects of the present disclosure may enable users to create policies with more granularity. For example, users of the security cloud service 205 can create policies at the object level 305, the cluster level 310, or the SLA level 315, which provides more flexibility. In accordance with the QAuth techniques described herein, users can select inventory types and add specific inventories to the policy, thereby reducing approval requirements for protected actions (e.g., deleting snapshots) to the selected items. The techniques described herein may also enable administrative users (such as the user 220-a) to designate a QAuth approver (such as the user 220-b) for specific operations. Within the security cloud service 205, approvers can be designated to authorize specific operations (and not others).

The described techniques may enable QAuth approvers to have other non-approval RBAC roles at the same time. In other words, an approver can be listed in a regular (e.g., non-TPR) user hierarchy as well as a TPR/QAuth user hierarchy. QAuth approvers can be assigned with other RBAC roles, provided they do not have permission to managing user access privileges and approve request permissions at the same time. When submitting a QAuth request 245, a requestor (such as the user 220-c) can choose the execution type (e.g., automatic or manual). If the execution type is manual, the approver (e.g., the user 220-b) can set a time window for manual execution (thereby providing additional security control).

In some implementations, the QAuth policy may enable exempt service accounts to bypass QAuth measures, if they are added as exempt service accounts under the QAuth policy. This may enable clients of the security cloud service 205 to use automation for protected operations. The QAuth schemes described herein can be configured to require agreement (e.g., approval) from more than two people on a given action. In some implementations, the number of approvals needed can be configured within the policy. The described techniques may also support multi-tenancy authorization. For example, tenant users may be subject to QAuth approval processes when taking any action(s) governed by a QAuth policy, which may involve submitting a request to perform a specific action. Aspects of the present disclosure may also enable tenant organizations to configure and use QAuth in their organizations.

A global administrator (such as the user 220-a) can enable QAuth via the security cloud service 205. To configure a QAuth policy, a QAuth administrative role can be created and assigned to an existing local user account. The security cloud service 205 may verify that the local user does not have manage user access permission before assigning the QAuth administrative role. Some static policies may be automatically created if, for example, the action involves assigning QAuth roles to other users, deleting a QAuth policy, disabling QAuth, etc. A QAuth administrative user can approve any action within the scope of a static policy. Additionally, or alternatively, users of the security cloud service 205 can add custom QAuth policies. As described herein, a QAuth policy may contain various QAuth actions, object scope(s) and exempt service accounts. QAuth actions may include system configuration actions or data management actions (but not both). For data management actions, users can add specific inventory objects/clusters/SLAs to the policy.

In some implementations, a global administrator (such as the user 220-a) may be able to create a custom QAuth policy. After creating a policy, the global administrator can add the policy to a custom RBAC role with approving QAuth request permission. Accordingly, the global administrator can assign the RBAC role to users/groups, allowing them to approve specific actions within the scope of the QAuth policy. If, for example, a global administrator wants to edit a QAuth policy (e.g., to reduce the object scope, remove a protected action, or add an exempt service account), such actions may require approval from a QAuth administrative user to confirm the changes. This may ensure that global administrators cannot subvert QAuth measures by tweaking policy details.

When submitting a QAuth request, users can choose the execution type as automatic or manual. When approvers review QAuth request details, they can view more information about the request, such as the action name, policy name, object names, requested changes, etc. A requester may view and cancel QAuth requests they created. In some examples, a QAuth request may trigger multiple policies. In such cases, the security cloud service 205 may request approval from at least one authorized user for each policy. After obtaining all necessary approvals, automatically scheduled requests may be executed immediately, and manually scheduled requests can be executed later (before the request expires).

A global administrator (such as the user 220-a) can view and cancel QAuth requests 245 from anyone. Non-administrative users (such as the user 220-c) may be unable to view QAuth requests 245 from other users. A QAuth administrator can view, approve, and/or deny requests within the scope of static policies (e.g., disable QAuth, assign a QAuth admin/approver role). A QAuth approver (such as the user 220-b) can view, approve, and/or deny QAuth requests 245 within the scope of specific custom policies (e.g., a data management policy or a system setting policy). In some implementations, the number of approvals needed to execute an action may be defined within the QAuth policy configuration 225.

The techniques described herein may prevent actors (e.g., global administrators) from creating another user account to bypass QAuth protection. For example, the security cloud service 205 may enforce the following rules using an RBAC enforcement scheme: a user should not have permission to manage user access and approve QAuth request permissions at the same time. These rules may be enforced by the endpoints of role assignment/management. If a user does have both permissions, the user may be limited to approving QAuth requests (and may be unable to manage user access privileges). Any actions like assigning/revoking the permission of an approving QAuth request or managing a user with QAuth request approval permissions may require QAuth approvals from QAuth admins.

The security cloud service 205 may use a QAuth policy enforcer to check every operation that falls within the scope of predefined policies, blocking such requests until all necessary approvals are received. In some implementations, the QAuth policy enforcer may be implemented as middleware on an API server. The QAuth policy enforcer may check each operation/API call against a QAuth policy. As described herein, a QAuth policy may include QAuth actions and corresponding protection objects (e.g., compute objects 210). Each API may be mapped to a QAuth action, and the input of each API call may contain a list of compute objects 210 for the QAuth enforcer to check. If an [action, object] pair is a part of a QAuth policy, a QAuth request may be created/submitted. Compute objects 210 may inherit protection from their ancestors, meaning a policy assigned to an ancestor object can also be applied to descendant objects in the object hierarchy. In other words, policy inheritance may also be supported (similar to RBAC permissions), meaning that a policy assigned to an object would also apply to its descendants. The QAuth techniques described herein may be triggered by a request to perform a protected action on at least one compute object, which itself or its ancestor is of the one or more compute objects to which the QAuth policy is assigned. For multi-tenancy, a policy created in a global organization will thus be respected in tenant organizations as well.

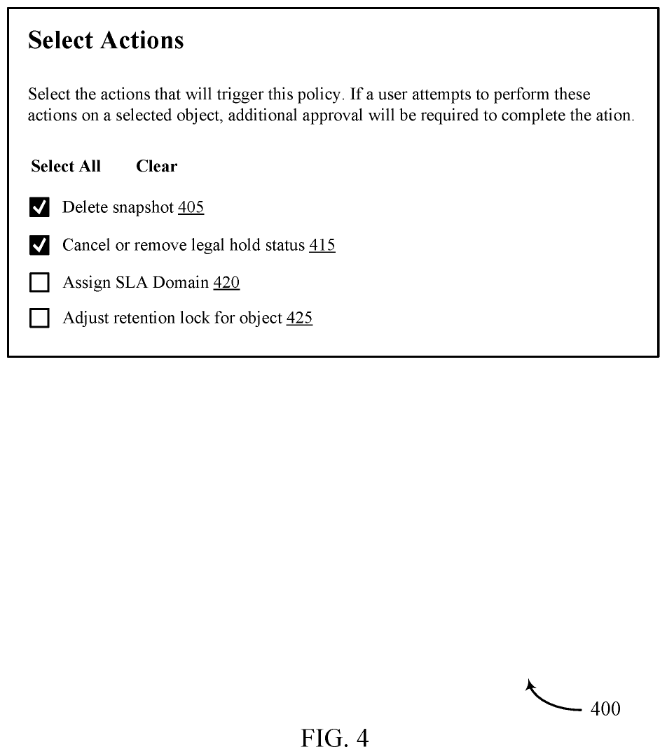

FIG. 4 shows an example of a user interface 400 that supports QAuth techniques in accordance with aspects of the present disclosure. The user interface 400 may implement one or more aspects of the computing environment 100 and/or the computing environment 200. For example, the user interface 400 may be configured by or otherwise associated with the security cloud service 205, as shown and described with reference to FIG. 2. The user interface 400 may be rendered or otherwise displayed on the computing device 215-a associated with the user 220-a (e.g., a global administrator), as shown and described with reference to FIG. 2. The user interface 400 depicted in the example of FIG. 4 may enable the user 220-a to select or otherwise configure a set of protected actions for a QAuth policy.

As described herein, a QAuth policy may have an object-level policy per operation, and may provide greater flexibility to assign approvers to specific policies. The number of approvers required may be configurable (e.g., any number greater than 2). In some implementations, QAuth policies may be defined across multiple clusters, and QAuth approvers (such as the user 220-b) may also have non-approver permissions (except for updating/managing user access permissions). The QAuth techniques described herein may support two different execution schemes: automatic execution after approval; and manual execution after approval. The described techniques may also support multi-tenancy and policy bypass for specific service accounts.

Aspects of the present disclosure may enable users to create policies with more granularity. For example, users of the security cloud service 205 can create policies at the object level 305, the cluster level 310, or the SLA level 315, which provides more flexibility. In accordance with the QAuth techniques described herein, users can select inventory types and add specific inventories to the policy, thereby reducing approval requirements for protected actions to the selected items. As depicted in the user interface 400, the list of actions protected by a given QAuth policy may include deleting a snapshot 405, canceling or removing a legal hold status 415, assigning an SLA domain 420, or adjusting a retention lock 425 for a compute object 210, among other examples. The techniques described herein may also enable administrative users (such as the user 220-a) to designate a QAuth approver (such as the user 220-b) for specific operations. Within the security cloud service 205, approvers can be designated to authorize specific operations (and not others).

The security cloud service 205 may use a QAuth policy enforcer to check every operation that falls within the scope of predefined policies, blocking such requests until all necessary approvals are received. In some implementations, the QAuth policy enforcer may be implemented as middleware on an API server. The QAuth policy enforcer may check each operation/API call against a QAuth policy. As described herein, a QAuth policy may include QAuth actions and corresponding protection objects (e.g., compute objects 210). Each API may be mapped to a QAuth action, and the input of each API call may contain a list of compute objects 210 for the QAuth enforcer to check. If an [action, object] pair is a part of a QAuth policy, a QAuth request may be created/submitted. Compute objects 210 may inherit protection from their ancestors, meaning a policy assigned to an ancestor object can also be applied to descendant objects in the object hierarchy. For multi-tenancy, a policy created in a global organization will thus be respected in tenant organizations as well.

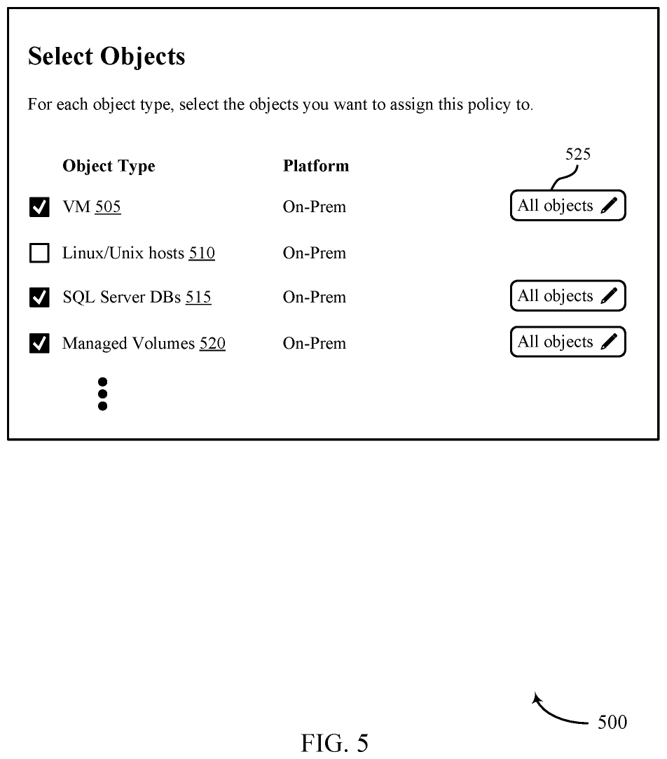

FIG. 5 shows an example of a user interface 500 that supports QAuth techniques in accordance with aspects of the present disclosure. The user interface 500 may implement one or more aspects of the computing environment 100 and/or the computing environment 200. For example, the user interface 500 may be configured by or otherwise associated with the security cloud service 205, as shown and described with reference to FIG. 2. The user interface 500 may be rendered or otherwise displayed on the computing device 215-a associated with the user 220-a (e.g., a global administrator), as shown and described with reference to FIG. 2. The user interface 500 depicted in the example of FIG. 5 may enable the user 220-a to select or otherwise assign a set of compute objects 210 to a QAuth policy, as described herein.

As described herein, a QAuth policy may have an object-level policy per operation, and may provide greater flexibility to assign approvers to specific policies. As depicted in the user interface 500, the compute objects 210 to which a QAuth policy is assigned may include a VM 505, a Linux/Unix/Windows host 510, a structured query language (SQL) server database 515, a managed volume 520, or a NAS host, among other examples. The user interface 500 may also provide users with the option 525 to assign/select a subset of objects of a given object type. The number of approvers required may be configurable (e.g., any number greater than 2). In some implementations, QAuth policies may be defined across multiple clusters, and QAuth approvers (such as the user 220-b) may also have non-approver permissions (except for updating/managing user access permissions). The QAuth techniques described herein may support two different execution schemes: automatic execution after approval; and manual execution after approval. The described techniques may also support multi-tenancy and policy bypass for specific service accounts.

Aspects of the present disclosure may enable users to create policies with more granularity. For example, users of the security cloud service 205 can create policies at the object level 305, the cluster level 310, or the SLA level 315, which provides more flexibility. In accordance with the QAuth techniques described herein, users can select inventory types and add specific inventories to the policy, thereby reducing approval requirements for protected actions to the selected items. As depicted in the user interface 400, the list of actions protected by a given QAuth policy may include deleting a snapshot 405, canceling or removing a legal hold status 415, assigning an SLA domain 420, or adjusting a retention lock 425 for a compute object 210, among other examples. The techniques described herein may also enable administrative users (such as the user 220-a) to designate a QAuth approver (such as the user 220-b) for specific operations. Within the security cloud service 205, approvers can be designated to authorize specific operations (and not others).

The security cloud service 205 may use a QAuth policy enforcer to check every operation that falls within the scope of predefined policies, blocking such requests until all necessary approvals are received. In some implementations, the QAuth policy enforcer may be implemented as middleware on an API server. The QAuth policy enforcer may check each operation/API call against a QAuth policy. As described herein, a QAuth policy may include QAuth actions and corresponding protection objects (e.g., compute objects 210). Each API may be mapped to a QAuth action, and the input of each API call may contain a list of compute objects 210 for the QAuth enforcer to check. If an [action, object] pair is a part of a QAuth policy, a QAuth request may be created/submitted. Compute objects 210 may inherit protection from their ancestors, meaning a policy assigned to an ancestor object can also be applied to descendant objects in the object hierarchy. For multi-tenancy, a policy created in a global organization will thus be respected in tenant organizations as well.

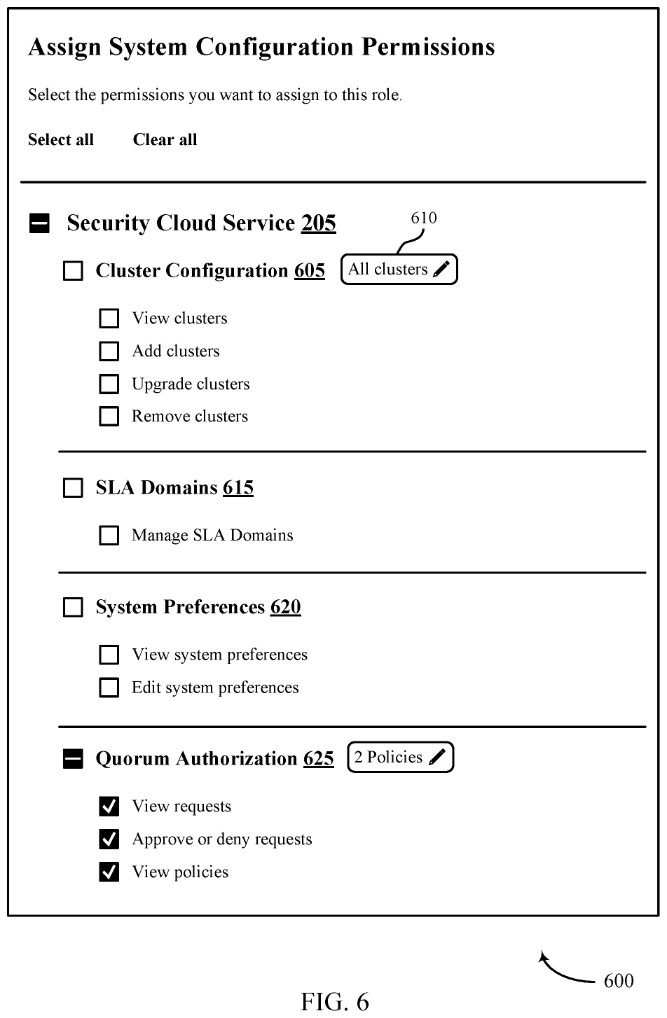

FIG. 6 shows an example of a user interface 600 that supports QAuth techniques in accordance with aspects of the present disclosure. The user interface 600 may implement one or more aspects of the computing environment 100 and/or the computing environment 200. For example, the user interface 600 may be configured by or otherwise associated with the security cloud service 205, as shown and described with reference to FIG. 2. The user interface 600 may be rendered or otherwise displayed on the computing device 215-a associated with the user 220-a (e.g., a global administrator), as shown and described with reference to FIG. 2. The user interface 600 depicted in the example of FIG. 6 may enable the user 220-a to select or otherwise assign a set of system configuration permissions to an RBAC role, as described herein.

In some implementations, a global administrator (such as the user 220-a) may be able to create a custom QAuth policy. After creating a custom policy, the global administrator can add the policy to a custom RBAC role with approving QAuth request permission. For example, as depicted in the user interface 600, the global administrator can assign one or more cluster configuration permissions 605, SLA domain permissions 615, system preference permissions 620, and/or QAuth permissions 625 to a custom RBAC role. The user interface 600 may also enable the global administrator to assign specific operational privileges (e.g., view clusters, manage SLA domains, view QAuth requests) within a given permission category. Once created, the global administrator can assign the custom RBAC role to users/groups, allowing them to approve specific actions within the scope of the QAuth policy. If, for example, a global administrator wants to edit a QAuth policy (e.g., to reduce the object scope, remove a protected action, or add an exempt service account), such actions may require approval from a QAuth administrative user to confirm the changes. This helps ensure that global administrators cannot subvert QAuth measures by tweaking policy details.

A global administrator (such as the user 220-a) can view and cancel QAuth requests 245 from anyone. Non-administrative users (such as the user 220-c) may be unable to view QAuth requests 245 from other users. A QAuth administrator can view, approve, and/or deny requests within the scope of static policies (e.g., disable QAuth, assign a QAuth admin/approver role). A QAuth approver (such as the user 220-b) can view, approve, and/or deny QAuth requests 245 within the scope of specific custom policies (e.g., a data management policy or a system setting policy). In some implementations, the number of approvals needed to execute an action may be defined within the QAuth policy configuration 225.

FIG. 7 shows an example of a user interface 700 that supports QAuth techniques in accordance with aspects of the present disclosure. The user interface 700 may implement one or more aspects of the computing environment 100 and/or the computing environment 200. For example, the user interface 700 may be configured by or otherwise associated with the security cloud service 205, as shown and described with reference to FIG. 2. The user interface 700 may be rendered or otherwise displayed on the computing device 215-a associated with the user 220-a (e.g., a global administrator), as shown and described with reference to FIG. 2. The user interface 700 depicted in the example of FIG. 7 may enable the user 220-a to select or otherwise assign one or more QAuth policies to an RBAC role, as described herein.

As described herein, a QAuth policy may have an object-level policy per operation, and may provide greater flexibility to assign approvers to specific policies. As shown in the user interface 700, a global administrator can choose to assign all existing and future policies 705 or specific policies 710 to a given approver. If the latter is chosen, the global administrator can select which policies to assign to a given RBAC role. For example, the global administrator may choose to assign an SLA-related policy 715 and a system-config-policy 725 to the RBAC role, while omitting a VM-del-policy 720. In some implementations, QAuth policies may be defined across multiple clusters, and QAuth approvers (such as the user 220-b) may also have non-approver permissions (except for updating/managing user access permissions). The QAuth techniques described herein may support two different execution schemes: automatic execution after approval; and manual execution after approval. The described techniques may also support multi-tenancy and policy bypass for specific service accounts.

Aspects of the present disclosure may enable users to create policies with more granularity. For example, users of the security cloud service 205 can create policies at the object level 305, the cluster level 310, or the SLA level 315, which provides more flexibility. In accordance with the QAuth techniques described herein, users can select inventory types and add specific inventories to the policy, thereby reducing approval requirements for protected actions (e.g., deleting snapshots) to the selected items. The techniques described herein may also enable administrative users (such as the user 220-a) to designate a QAuth approver (such as the user 220-b) for specific operations. Within the security cloud service 205, approvers can be designated to authorize specific operations (and not others).

FIG. 8 shows an example of a QAuth request 800 that supports QAuth techniques in accordance with aspects of the present disclosure. The QAuth request 800 may implement one or more aspects of the computing environment 100 and/or the computing environment 200. For example, the QAuth request 800 may be transmitted or otherwise provided by the security cloud service 205, as shown and described with reference to FIG. 2. The QAuth request 800 may be rendered or otherwise displayed via a user interface of the computing device 215-b associated with the user 220-b (e.g., a QAuth approver), as shown and described with reference to FIG. 2. The QAuth request 800 depicted in the example of FIG. 8 may contain information associated with one or more protected action(s) requested by the computing device 215-c associated with the user 220-c, as described herein.

When submitting the QAuth request 800, users can choose the execution type as automatic or manual. As shown in the example of FIG. 8, the QAuth request 800 may include various details and information about the request, such as a request summary 805, details about the requested change 810, a run type 815 for the requested actions (e.g., manual or automatic), and other pertinent details (such as a list of selected SLA domains). A QAuth requester (such as the user 220-c) may view and cancel QAuth requests 800 they created. In some examples, a QAuth request 800 may trigger multiple policies. In such cases, the security cloud service 205 may request approval from at least one authorized user for each policy implicated by the QAuth request 800. After obtaining all necessary approvals, automatically scheduled QAuth requests 800 may be executed immediately, and manually scheduled QAuth requests 800 can be executed later (before the request expires).

A global administrator (such as the user 220-a) can view and cancel QAuth requests 800 from anyone, whereas non-administrative users (such as the user 220-c) may be unable to view QAuth requests 800 from other users. A QAuth administrator can view, approve, and/or deny QAuth requests 800 within the scope of static policies (e.g., disable QAuth, assign a QAuth admin/approver role). A QAuth approver (such as the user 220-b) can view; approve, and/or deny QAuth requests 800 within the scope of specific custom policies (e.g., a data management policy or a system setting policy). In some implementations, the number of approvals needed to execute an action may be defined within the QAuth policy configuration 225.

The techniques described herein may prevent actors (e.g., global administrators) from creating another user account to bypass QAuth protection. For example, the security cloud service 205 may enforce the following rules using an RBAC enforcer: a user should not have permission to manage user access and approve QAuth requests 800 at the same time. These rules may be enforced by the endpoints of role assignment/management. If a user does have both permissions, the user may be limited to approving QAuth requests (and may be unable to manage user access privileges). Any actions like assigning/revoking the permission of an approving QAuth requests 800 or managing a user with QAuth request approval permissions may require approval from QAuth admin(s).

The security cloud service 205 may use a QAuth policy enforcer to check every operation that falls within the scope of predefined policies, blocking such requests until all necessary approvals are received. In some implementations, the QAuth policy enforcer may be implemented as middleware on an API server. The QAuth policy enforcer may check each operation/API call against a QAuth policy. As described herein, a QAuth policy may include QAuth actions and corresponding protection objects (e.g., compute objects 210). Each API may be mapped to a QAuth action, and the input of each API call may contain a list of compute objects 210 for the QAuth enforcer to check. If an [action, object] pair is a part of a QAuth policy, a QAuth request 800 may be created/submitted. Compute objects 210 may inherit protection from their ancestors, meaning a policy assigned to an ancestor object can also be applied to descendant objects in the object hierarchy. For multi-tenancy, a policy created in a global organization will thus be respected in tenant organizations as well.

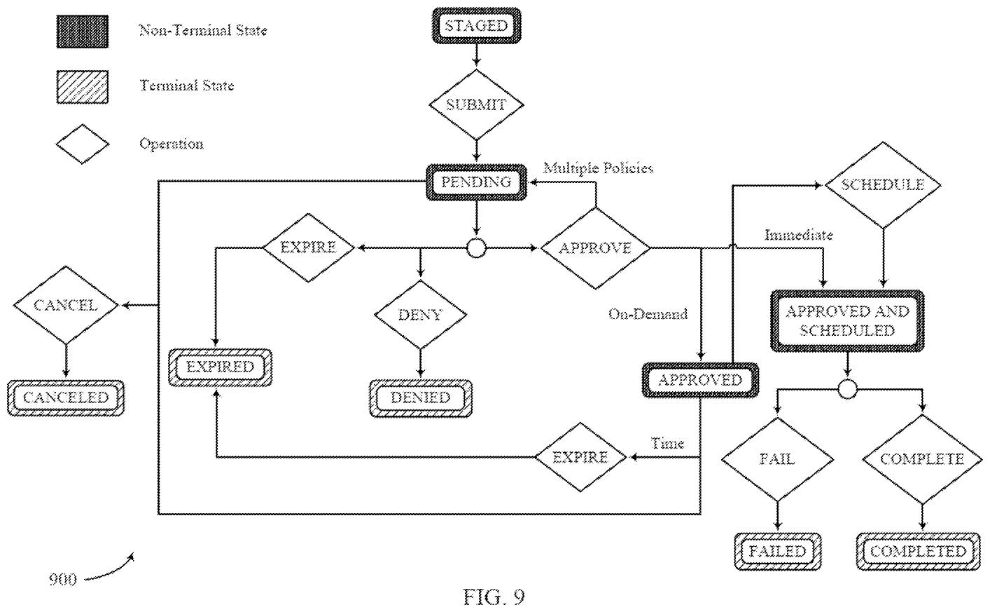

FIG. 9 shows an example of a process flow 900 that supports QAuth techniques in accordance with aspects of the present disclosure. The process flow 900 may implement one or more aspects of the computing environment 100 and/or the computing environment 200. For example, operations of the process flow 900 may be implemented (at least in part) by the security cloud service 205 of the DMS 110, as shown and described with reference to FIGS. 1 and 2. In the following description of the process flow 900, some operations may be added, omitted, or performed in a different order (with respect to the exemplary order shown).

When a QAuth request 800 is first submitted, the QAuth request 800 may transition from staged to pending. In some examples, the QAuth request 800 may be canceled by the requesting user (such as the user 220-c) or a global administrator (such as the user 220-a). In other examples, the QAuth request 800 may expire after a certain time. In other examples, the QAuth request 800 may be denied by a QAuth approver (such as the user 220-b) or a global administrator. If the QAuth request 800 is approved, the security cloud service 205 may check the requested execution/run type. If the run type is on-demand (e.g., manual), the security cloud service 205 may wait for the requesting user to schedule/execute the approved action(s). In some cases, the QAuth request 800 may expire after being approved (if the requesting user does not schedule/execute the approved action(s) within a given window.

If the run type is immediate (e.g., automatic), the security cloud service 205 may execute the approved action(s) accordingly. If the run is successful, the security cloud service 205 may designate the QAuth request 800 as completed. Otherwise (e.g., if the run is unsuccessful or an error occurs), the security cloud service 205 may designate the QAuth request 800 as failed. In some examples, the security cloud service 205 may notify the requesting user of the status of the QAuth request 800 (e.g., pending, canceled, expired, denied, failed, completed).

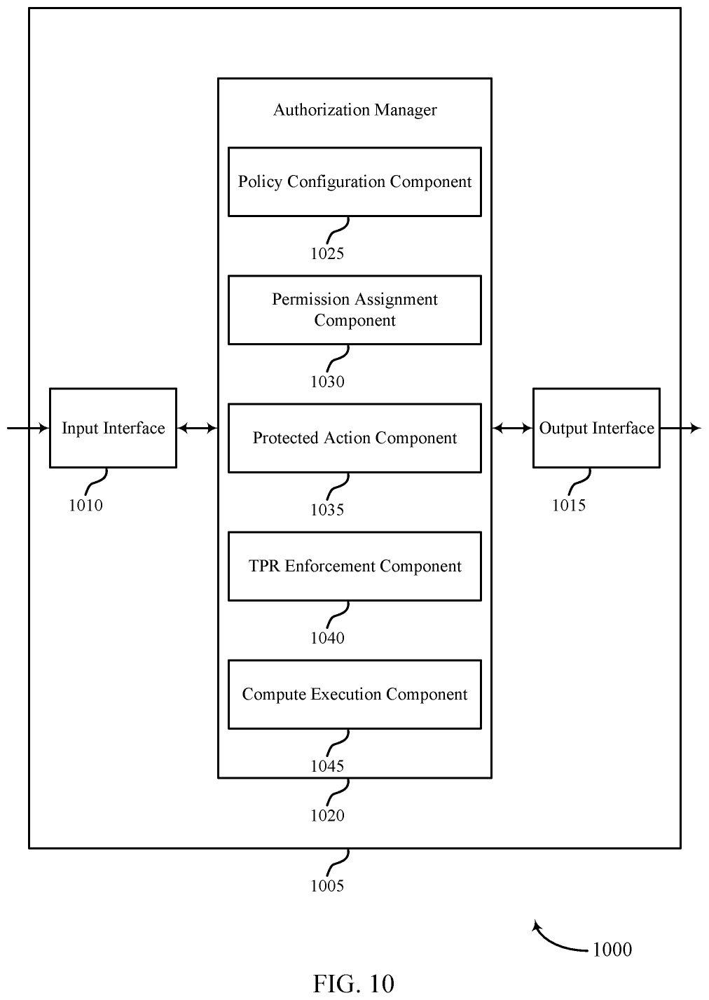

FIG. 10 shows a block diagram 1000 of a system 1005 that supports QAuth techniques in accordance with aspects of the present disclosure. In some examples, the system 1005 may be an example of aspects of one or more components described with reference to FIG. 1, such as a DMS 110. The system 1005 may include an input interface 1010, an output interface 1015, and an authorization manager 1020. The system 1005 may also include one or more processors. Each of these components may be in communication with one another (e.g., via one or more buses, communications links, communications interfaces, or any combination thereof).

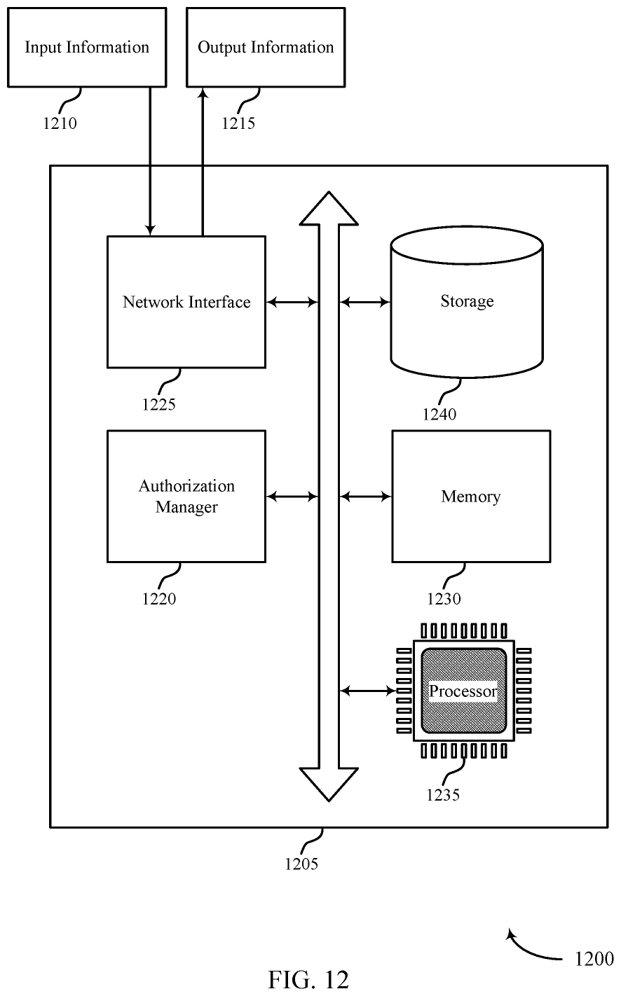

The input interface 1010 may manage input signaling for the system 1005. For example, the input interface 1010 may receive input signaling (e.g., messages, packets, data, instructions, commands, or any other form of encoded information) from other systems or devices. The input interface 1010 may send signaling corresponding to (e.g., representative of or otherwise based on) such input signaling to other components of the system 1005 for processing. For example, the input interface 1010 may transmit such corresponding signaling to the authorization manager 1020 to support QAuth techniques. In some cases, the input interface 1010 may be a component of a network interface 1225 as described with reference to FIG. 12.

The output interface 1015 may manage output signaling for the system 1005. For example, the output interface 1015 may receive signaling from other components of the system 1005, such as the authorization manager 1020, and may transmit such output signaling corresponding to (e.g., representative of or otherwise based on) such signaling to other systems or devices. In some cases, the output interface 1015 may be a component of a network interface 1225 as described with reference to FIG. 12.

For example, the authorization manager 1020 may include a policy configuration component 1025, a permission assignment component 1030, a protected action component 1035, a TPR enforcement component 1040, a compute execution component 1045, or any combination thereof. In some examples, the authorization manager 1020, or various components thereof, may be configured to perform various operations (e.g., receiving, monitoring, transmitting) using or otherwise in cooperation with the input interface 1010, the output interface 1015, or both. For example, the authorization manager 1020 may receive information from the input interface 1010, send information to the output interface 1015, or be integrated in combination with the input interface 1010, the output interface 1015, or both to receive information, transmit information, or perform various other operations as described herein.

The policy configuration component 1025 may be configured as or otherwise support a means for receiving an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned. The permission assignment component 1030 may be configured as or otherwise support a means for receiving an instruction to assign a set of RBAC permissions associated with the QAuth policy to a first user of the two or more users. The protected action component 1035 may be configured as or otherwise support a means for receiving a request to perform a protected action on at least one compute object of the one or more compute objects to which the QAuth policy is assigned, the request originating from a second user of the two or more users. The TPR enforcement component 1040 may be configured as or otherwise support a means for triggering a TPR enforcement mechanism of the QAuth policy based on the request from the second user, where triggering the TPR enforcement mechanism includes requesting approval from the first user with the set of RBAC permissions. The compute execution component 1045 may be configured as or otherwise support a means for executing the protected action on the at least one compute object after receiving the approval from the first user with the set of RBAC permissions.

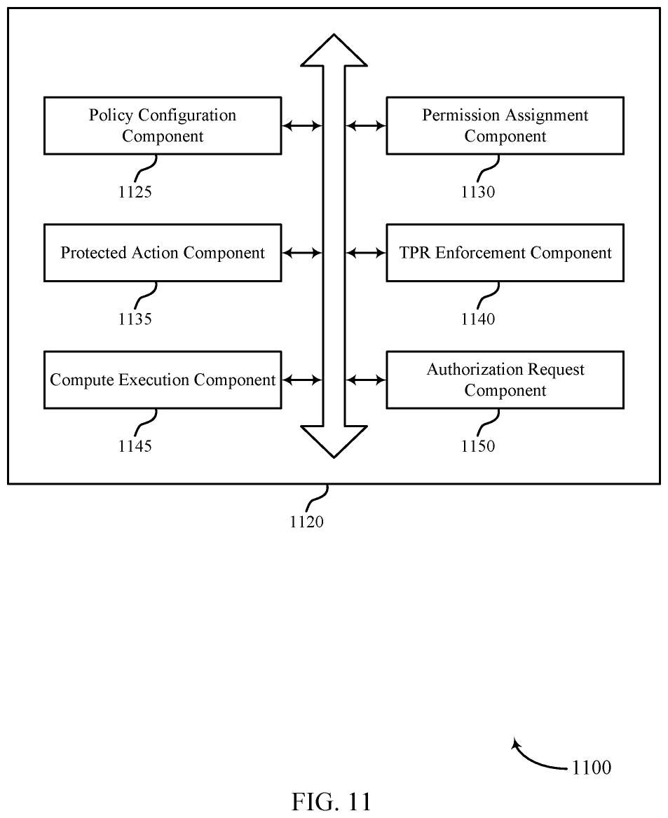

FIG. 11 shows a block diagram 1100 of an authorization manager 1120 that supports QAuth techniques in accordance with aspects of the present disclosure. The authorization manager 1120 may be an example of aspects of an authorization manager 1020, as described herein. The authorization manager 1120, or various components thereof, may be an example of means for performing various aspects of QAuth techniques as described herein. For example, the authorization manager 1120 may include a policy configuration component 1125, a permission assignment component 1130, a protected action component 1135, a TPR enforcement component 1140, a compute execution component 1145, an authorization request component 1150, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The policy configuration component 1125 may be configured as or otherwise support a means for receiving an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned. The permission assignment component 1130 may be configured as or otherwise support a means for receiving an instruction to assign a set of RBAC permissions associated with the QAuth policy to a first user of the two or more users. The protected action component 1135 may be configured as or otherwise support a means for receiving a request to perform a protected action on at least one compute object of the one or more compute objects to which the QAuth policy is assigned, the request originating from a second user of the two or more users. The TPR enforcement component 1140 may be configured as or otherwise support a means for triggering a TPR enforcement mechanism of the QAuth policy based on the request from the second user, where triggering the TPR enforcement mechanism includes requesting approval from the first user with the set of RBAC permissions. The compute execution component 1145 may be configured as or otherwise support a means for executing the protected action on the at least one compute object after receiving the approval from the first user with the set of RBAC permissions.

In some examples, to support configuring the policy scope for the QAuth policy, the policy configuration component 1125 may be configured as or otherwise support a means for assigning the QAuth policy to a set of compute objects within the DMS, a set of node clusters within the DMS, a set of SLA domains within the DMS, or any combination thereof.

In some examples, the one or more protected actions that trigger the QAuth policy include deleting a snapshot of a compute object within the DMS, modifying a legal hold status of a compute object within the DMS, assigning an SLA domain to at least one compute object within the DMS, or adjusting a retention lock on a compute object within the DMS.

In some examples, the one or more compute objects to which the QAuth policy is assigned include at least one of a VM, a system host, a database, or a managed data volume. In some examples, the QAuth policy is configured by a global administrator of the security cloud service.

In some examples, the request to perform the protected action on the at least one compute object further indicates an execution type for the protected action, an identifier of the QAuth policy, an identifier of the protected action, a timestamp associated with the request, data associated with the at least one compute object, a set of service identifiers that are exempt from the QAuth policy, or any combination thereof.

In some examples, the permission assignment component 1130 may be configured as or otherwise support a means for receiving a request to assign a second set of RBAC permissions to the first user in addition to the set of RBAC permissions associated with the QAuth policy.

In some examples, the protected action component 1135 may be configured as or otherwise support a means for determining that the request to perform the protected action triggers two or more QAuth policies of the security cloud service. In some examples, the protected action component 1135 may be configured as or otherwise support a means for refraining from executing the protected action until approval is received for each of the two or more QAuth policies triggered by the request.

In some examples, the authorization request component 1150 may be configured as or otherwise support a means for receiving, from the global administrator, a request to view or cancel one or more QAuth requests from other users of the security cloud service. In some examples, the security cloud service of the DMS supports multi-tenant QAuth.

In some examples, the policy configuration component 1125 may be configured as or otherwise support a means for receiving, from the global administrator, a request to edit the configuration of the QAuth policy. In some examples, the authorization request component 1150 may be configured as or otherwise support a means for requesting approval from the first user with the set of RBAC permissions before changing the configuration of the QAuth policy in accordance with the request.

In some examples, the global administrator is authorized to view, approve, and deny QAuth requests within the policy scope of the QAuth policy, disable the QAuth policy, assign RBAC permissions to other users of the security cloud service, or any combination thereof.

In some examples, the set of RBAC permissions assigned to the first user include viewing, approving, and denying QAuth requests within the policy scope of the QAuth policy. In some examples, the set of RBAC permissions assigned to the first user exclude managing user access permissions for the QAuth policy.

In some examples, the protected action component 1135 may be configured as or otherwise support a means for comparing the protected action and the at least one compute object to a list of protected action-object pairs for the QAuth policy, where triggering the TPR enforcement mechanism of the QAuth policy is based on determining that the protected action and the at least one compute object are present on the list of protected action-object pairs.

In some examples, to support triggering the TPR enforcement mechanism, the authorization request component 1150 may be configured as or otherwise support a means for transmitting a QAuth request to the first user with the set of RBAC permissions based at least determining that the at least one compute object is a descendent of an ancestor object protected by the QAuth policy.

FIG. 12 shows a block diagram 1200 of a system 1205 that supports QAuth techniques in accordance with aspects of the present disclosure. The system 1205 may be an example of or include the components of a system 1005, as described herein. The system 1205 may include components for data management, including components such as an authorization manager 1220, an input information 1210, an output information 1215, a network interface 1225, at least one memory 1230, at least one processor 1235, and a storage 1240. These components may be in electronic communication or otherwise coupled with each other (e.g., operatively, communicatively, functionally, electronically, electrically; via one or more buses, communications links, communications interfaces, or any combination thereof). Additionally, the components of the system 1205 may include corresponding physical components or may be implemented as corresponding virtual components (e.g., components of one or more VMs). In some examples, the system 1205 may be an example of aspects of one or more components described with reference to FIG. 1, such as a DMS 110.

The network interface 1225 may enable the system 1205 to exchange information (e.g., input information 1210, output information 1215, or both) with other systems or devices (not shown). For example, the network interface 1225 may enable the system 1205 to connect to a network (e.g., a network 120 as described herein). The network interface 1225 may include one or more wireless network interfaces, one or more wired network interfaces, or any combination thereof. In some examples, the network interface 1225 may be an example of may be an example of aspects of one or more components described with reference to FIG. 1, such as one or more network interfaces 165.

Memory 1230 may include RAM, ROM, or both. The memory 1230 may store computer-readable, computer-executable software including instructions that, when executed, cause the processor 1235 to perform various functions described herein. In some cases, the memory 1230 may contain, among other things, a basic input/output system (BIOS), which may control basic hardware or software operation such as the interaction with peripheral components or devices. In some cases, the memory 1230 may be an example of aspects of one or more components described with reference to FIG. 1, such as one or more memories 175.

The processor 1235 may include an intelligent hardware device, (e.g., a general-purpose processor, a digital signal processor (DSP), a central processing unit (CPU), a microcontroller, an application-specific integrated circuit (ASIC), a field programmable gate array (FPGA), a programmable logic device, a discrete gate or transistor logic component, a discrete hardware component, or any combination thereof). The processor 1235 may be configured to execute computer-readable instructions stored in a memory 1230 to perform various functions (e.g., functions or tasks supporting QAuth techniques). Though a single processor 1235 is depicted in the example of FIG. 12, it is to be understood that the system 1205 may include any quantity of one or more of processors 1235 and that a group of processors 1235 may collectively perform one or more functions ascribed herein to a processor, such as the processor 1235. In some cases, the processor 1235 may be an example of aspects of one or more components described with reference to FIG. 1, such as one or more processors 170.

Storage 1240 may be configured to store data that is generated, processed, stored, or otherwise used by the system 1205. In some cases, the storage 1240 may include one or more HDDs, one or more SSDs, or both. In some examples, the storage 1240 may be an example of a single database, a distributed database, multiple distributed databases, a data store, a data lake, or an emergency backup database. In some examples, the storage 1240 may be an example of one or more components described with reference to FIG. 1, such as one or more network disks 180.

For example, the authorization manager 1220 may be configured as or otherwise support a means for receiving an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned. The authorization manager 1220 may be configured as or otherwise support a means for receiving an instruction to assign a set of RBAC permissions associated with the QAuth policy to a first user of the two or more users. The authorization manager 1220 may be configured as or otherwise support a means for receiving a request to perform a protected action on at least one compute object of the one or more compute objects to which the QAuth policy is assigned, the request originating from a second user of the two or more users. The authorization manager 1220 may be configured as or otherwise support a means for triggering a TPR enforcement mechanism of the QAuth policy based on the request from the second user, where triggering the TPR enforcement mechanism includes requesting approval from the first user with the set of RBAC permissions. The authorization manager 1220 may be configured as or otherwise support a means for executing the protected action on the at least one compute object after receiving the approval from the first user with the set of RBAC permissions.

By including or configuring the authorization manager 1220 in accordance with examples as described herein, the system 1205 may support techniques for QAuth techniques, which may provide one or more benefits such as, for example, improved user experience and improved security, among other possibilities.

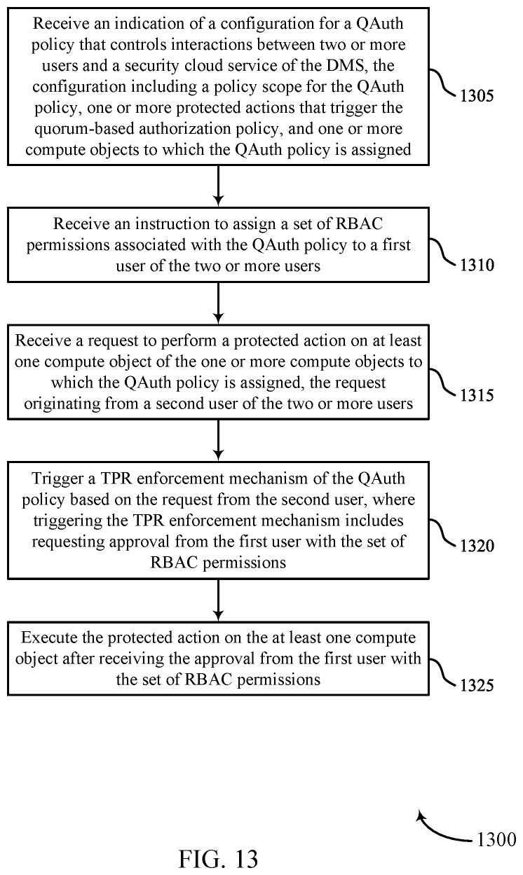

FIG. 13 shows a flowchart illustrating a method 1300 that supports QAuth techniques in accordance with aspects of the present disclosure. One or more operations of the method 1300 may be implemented by a DMS, such as the DMS 110 described with reference to FIG. 1. In some examples, the DMS may execute a set of instructions to control the functional elements of the DMS to perform the described functions. Additionally, or alternatively, the DMS may perform aspects of the described functions using special-purpose hardware.

At 1305, the DMS may receive an indication of a configuration for a QAuth policy that controls interactions between two or more users and a security cloud service of the DMS, the configuration including a policy scope for the QAuth policy, one or more protected actions that trigger the QAuth policy, and one or more compute objects to which the QAuth policy is assigned. In some examples, aspects of the operations of 1305 may be performed by a policy configuration component 1125, as described with reference to FIG. 11.

At 1310, the DMS may receive an instruction to assign a set of RBAC permissions associated with the QAuth policy to a first user of the two or more users. In some examples, aspects of the operations of 1310 may be performed by a permission assignment component 1130, as described with reference to FIG. 11.

At 1315, the DMS may receive a request to perform a protected action on at least one compute object of the one or more compute objects to which the QAuth policy is assigned, the request originating from a second user of the two or more users. In some examples, aspects of the operations of 1315 may be performed by a protected action component 1135, as described with reference to FIG. 11.

At 1320, the DMS may trigger a TPR enforcement mechanism of the QAuth policy based on the request from the second user, where triggering the TPR enforcement mechanism includes requesting approval from the first user with the set of RBAC permissions. In some examples, aspects of the operations of 1320 may be performed by a TPR enforcement component 1140, as described with reference to FIG. 11.

At 1325, the DMS may execute the protected action on the at least one compute object after receiving the approval from the first user with the set of RBAC permissions. In some examples, aspects of the operations of 1325 may be performed by a compute execution component 1145, as described with reference to FIG. 11.

A method is described. The method may include: receiving an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned; receiving an instruction to assign a set of RBAC permissions associated with the QAuth policy to a first user of the two or more users; receiving a request to perform a protected action on at least one compute object of the one or more compute objects to which the QAuth policy is assigned, the request originating from a second user of the two or more users; triggering a TPR enforcement mechanism of the QAuth policy based on the request from the second user, where triggering the TPR enforcement mechanism includes requesting approval from the first user with the set of RBAC permissions; and executing the protected action on the at least one compute object after receiving the approval from the first user with the set of RBAC permissions.

An apparatus is described. The apparatus may include one or more memories storing processor-executable code, and one or more processors coupled with the one or more memories. The one or more processors may be individually or collectively operable to execute the code to cause the apparatus to: receive an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned; receive an instruction to assign a set of RBAC permissions associated with the QAuth policy to a first user of the two or more users; receive a request to perform a protected action on at least one compute object of the one or more compute objects to which the QAuth policy is assigned, the request originating from a second user of the two or more users; trigger a TPR enforcement mechanism of the QAuth policy based on the request from the second user, where triggering the TPR enforcement mechanism includes requesting approval from the first user with the set of RBAC permissions; and execute the protected action on the at least one compute object after receiving the approval from the first user with the set of RBAC permissions.

A non-transitory computer-readable medium is described. The non-transitory computer-readable medium may include instructions executable by at least one processor to: receive an indication of a configuration for a QAuth policy that controls interactions between two or more users and a security cloud service of a DMS, the configuration including a policy scope for the QAuth policy, one or more protected actions that trigger the QAuth policy, and one or more compute objects to which the QAuth policy is assigned; receive an instruction to assign a set of RBAC permissions associated with the QAuth policy to a first user of the two or more users; receive a request to perform a protected action on at least one compute object of the one or more compute objects to which the QAuth policy is assigned, the request originating from a second user of the two or more users; trigger a TPR enforcement mechanism of the QAuth policy based on the request from the second user, where triggering the TPR enforcement mechanism includes requesting approval from the first user with the set of RBAC permissions; and execute the protected action on the at least one compute object after receiving the approval from the first user with the set of RBAC permissions.

In some examples described herein, configuring the policy scope for the QAuth policy may include operations, features, means, or instructions for assigning the QAuth policy to a set of compute objects within the DMS, a set of node clusters within the DMS, a set of SLA domains within the DMS, or any combination thereof.

In some examples described herein, the one or more protected actions that trigger the QAuth policy include deleting a snapshot of a compute object within the DMS, modifying a legal hold status of a compute object within the DMS, assigning an SLA domain to at least one compute object within the DMS, or adjusting a retention lock on a compute object within the DMS.

In some examples described herein, the one or more compute objects to which the QAuth policy is assigned include at least one of a VM, a system host, a database, or a managed data volume.

In some examples described herein, the request to perform the protected action on the at least one compute object further indicates an execution type for the protected action, an identifier of the QAuth policy, an identifier of the protected action, a timestamp associated with the request, data associated with the at least one compute object, a set of service identifiers that are exempt from the QAuth policy, or any combination thereof.

Some examples described herein may further include operations, features, means, or instructions for receiving a request to assign a second set of RBAC permissions to the first user in addition to the set of RBAC permissions associated with the QAuth policy.

Some examples described herein may further include operations, features, means, or instructions for: determining that the request to perform the protected action triggers two or more QAuth policies of the security cloud service; and refraining from executing the protected action until approval is received for each of the two or more QAuth policies triggered by the request.

In some examples described herein, the QAuth policy may be configured by a global administrator of the security cloud service. In some examples described herein, the security cloud service of the DMS supports multi-tenant QAuth.

Some examples described herein may further include operations, features, means, or instructions for receiving, from the global administrator, a request to view or cancel one or more QAuth requests from other users of the security cloud service.

Some examples described herein may further include operations, features, means, or instructions for: receiving, from the global administrator, a request to edit the configuration of the QAuth policy; and requesting approval from the first user with the set of RBAC permissions before changing the configuration of the QAuth policy in accordance with the request.

In some examples described herein, the global administrator may be authorized to view, approve, and deny QAuth requests within the policy scope of the QAuth policy, disable the QAuth policy, assign RBAC permissions to other users of the security cloud service, or any combination thereof.

In some examples described herein, the set of RBAC permissions assigned to the first user include viewing, approving, and denying QAuth requests within the policy scope of the QAuth policy. In some examples described herein, the set of RBAC permissions assigned to the first user exclude managing user access permissions for the QAuth policy.

Some examples described herein may further include operations, features, means, or instructions for comparing the protected action and the at least one compute object to a list of protected action-object pairs for the QAuth policy, where triggering the TPR enforcement mechanism of the QAuth policy is based on determining that the protected action and the at least one compute object are present on the list of protected action-object pairs.

In some examples described herein, triggering the TPR enforcement mechanism may include operations, features, means, or instructions for transmitting a QAuth request to the first user with the set of RBAC permissions based at least determining that the at least one compute object is a descendent of an ancestor object protected by the QAuth policy.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving an indication of a configuration for a quorum-based authorization policy that controls interactions between two or more users and a security cloud service of a data management system (DMS), the configuration including a policy scope for the quorum-based authorization policy, one or more protected actions that trigger the quorum-based authorization policy, and one or more compute objects to which the quorum-based authorization policy is assigned;
receiving an instruction to assign a set of role-based access control (RBAC) permissions associated with the quorum-based authorization policy to a first user of the two or more users;
receiving a request to perform a protected action on at least one compute object of the one or more compute objects to which the quorum-based authorization policy is assigned, the request originating from a second user of the two or more users;
triggering a two-person rule (TPR) enforcement mechanism of the quorum-based authorization policy based at least in part on the request from the second user, wherein triggering the TPR enforcement mechanism comprises requesting approval from the first user with the set of RBAC permissions; and
executing the protected action on the at least one compute object after receiving the approval from the first user with the set of RBAC permissions.

2. The method of claim 1, wherein configuring the policy scope for the quorum-based authorization policy comprises:
assigning the quorum-based authorization policy to a set of compute objects within the DMS, a set of node clusters within the DMS, a set of service level agreement (SLA) domains within the DMS, or any combination thereof.

3. The method of claim 1, wherein the one or more protected actions that trigger the quorum-based authorization policy comprise deleting a snapshot of a compute object within the DMS, modifying a legal hold status of a compute object within the DMS, assigning a service level agreement (SLA) domain to at least one compute object within the DMS, or adjusting a retention lock on a compute object within the DMS.

4. The method of claim 1, wherein the one or more compute objects to which the quorum-based authorization policy is assigned include at least one of a virtual machine (VM), a system host, a database, or a managed data volume.

5. The method of claim 1, wherein the request to perform the protected action on the at least one compute object further indicates an execution type for the protected action, an identifier of the quorum-based authorization policy, an identifier of the protected action, a timestamp associated with the request, data associated with the at least one compute object, a set of service identifiers that are exempt from the quorum-based authorization policy, or any combination thereof.

6. The method of claim 1, further comprising:
receiving a request to assign a second set of RBAC permissions to the first user in addition to the set of RBAC permissions associated with the quorum-based authorization policy.

7. The method of claim 1, further comprising:
determining that the request to perform the protected action triggers two or more quorum-based authorization policies of the security cloud service; and
refraining from executing the protected action until approval is received for each of the two or more quorum-based authorization policies triggered by the request.

8. The method of claim 1, wherein the quorum-based authorization policy is configured by a global administrator of the security cloud service.

9. The method of claim 8, further comprising:
receiving, from the global administrator, a request to view or cancel one or more quorum-based authorization requests from other users of the security cloud service.

10. The method of claim 8, further comprising:
receiving, from the global administrator, a request to edit the configuration of the quorum-based authorization policy; and
requesting approval from the first user with the set of RBAC permissions before changing the configuration of the quorum-based authorization policy in accordance with the request.

11. The method of claim 8, wherein the global administrator is authorized to view, approve, and deny quorum-based authorization requests within the policy scope of the quorum-based authorization policy, disable the quorum-based authorization policy, assign RBAC permissions to other users of the security cloud service, or any combination thereof.

12. The method of claim 1, wherein the set of RBAC permissions assigned to the first user comprise viewing, approving, and denying quorum-based authorization requests within the policy scope of the quorum-based authorization policy.

13. The method of claim 1, wherein the set of RBAC permissions assigned to the first user exclude managing user access permissions for the quorum-based authorization policy.

14. The method of claim 1, further comprising:
comparing the protected action and the at least one compute object to a list of protected action-object pairs for the quorum-based authorization policy, wherein triggering the TPR enforcement mechanism of the quorum-based authorization policy is based at least in part on determining that the protected action and the at least one compute object are present on the list of protected action-object pairs.

15. The method of claim 1, wherein triggering the TPR enforcement mechanism comprises:
transmitting a quorum-based authorization request to the first user with the set of RBAC permissions based at least determining that the at least one compute object is a descendent of an ancestor object protected by the quorum-based authorization policy.

16. The method of claim 1, wherein the security cloud service of the DMS supports multi-tenant quorum-based authorization.

17. An apparatus, comprising:
one or more memories storing processor-executable code; and
one or more processors coupled with the one or more memories and individually or collectively operable to execute the code to cause the apparatus to:
receive an indication of a configuration for a quorum-based authorization policy that controls interactions between two or more users and a security cloud service of a data management system (DMS), the configuration including a policy scope for the quorum-based authorization policy, one or more protected actions that trigger the quorum-based authorization policy, and one or more compute objects to which the quorum-based authorization policy is assigned;
receive an instruction to assign a set of role-based access control (RBAC) permissions associated with the quorum-based authorization policy to a first user of the two or more users;
receive a request to perform a protected action on at least one compute object of the one or more compute objects to which the quorum-based authorization policy is assigned, the request originating from a second user of the two or more users;
trigger a two-person rule (TPR) enforcement mechanism of the quorum-based authorization policy based at least in part on the request from the second user, wherein triggering the TPR enforcement mechanism comprises requesting approval from the first user with the set of RBAC permissions; and
execute the protected action on the at least one compute object after receiving the approval from the first user with the set of RBAC permissions.

18. The apparatus of claim 17, wherein, to configure the policy scope for the quorum-based authorization policy, the one or more processors are individually or collectively operable to execute the code to cause the apparatus to:
assign the quorum-based authorization policy to a set of compute objects within the DMS, a set of node clusters within the DMS, a set of service level agreement (SLA) domains within the DMS, or any combination thereof.

19. The apparatus of claim 17, wherein the one or more protected actions that trigger the quorum-based authorization policy comprise deleting a snapshot of a compute object within the DMS, modifying a legal hold status of a compute object within the DMS, assigning a service level agreement (SLA) domain to at least one compute object within the DMS, or adjusting a retention lock on a compute object within the DMS.

20. A non-transitory computer-readable medium storing instructions executable by one or more processors to:
receive an indication of a configuration for a quorum-based authorization policy that controls interactions between two or more users and a security cloud service of a data management system (DMS), the configuration including a policy scope for the quorum-based authorization policy, one or more protected actions that trigger the quorum-based authorization policy, and one or more compute objects to which the quorum-based authorization policy is assigned;
receive an instruction to assign a set of role-based access control (RBAC) permissions associated with the quorum-based authorization policy to a first user of the two or more users;
receive a request to perform a protected action on at least one compute object of the one or more compute objects to which the quorum-based authorization policy is assigned, the request originating from a second user of the two or more users;
trigger a two-person rule (TPR) enforcement mechanism of the quorum-based authorization policy based at least in part on the request from the second user, wherein triggering the TPR enforcement mechanism comprises requesting approval from the first user with the set of RBAC permissions; and
execute the protected action on the at least one compute object after receiving the approval from the first user with the set of RBAC permissions.
